(19) United States
(12) Patent Application Publication
(10) Pub. No.: US 2023/0368758 A1
(43) Pub. Date: Nov. 16, 2023

(54) SYSTEM AND METHOD FOR MUTATION TUNING OF AN AUDIO FILE

(71) Applicant: Stephen I. Kincaid, IV, Malibu, CA (US)

(72) Inventor: S. I. Kincaid, IV, Mal, CA (US)

(21) Appl. No.: 17/741,191

(22) Filed: May 10, 2022

(51) Int. Cl. G10H 1/00

(52) U.S. Cl. CPC G10H 1/0025; G10H 2210/105; G10H 2210/111; G10H 2210/131; G10H 2220/126; G10H 2250/311

(57) ABSTRACT

Disclosed is a system and method for mutating an audio file, and more particularly, for user-trained mutation tracking and tuning of an audio file, comprising the steps of: receiving a user input, wherein the user input is at least one of an audio file; entering at least a pattern into a grid sequencer by selecting any number of squares in the grid, wherein each square represents a particular count occupancy probability at a particular count in a musical composition bar that the user prefers to render as a final output; uploading at least one ‘good’ and ‘bad’ audio file sample by the user to affect the particular count occupancy probability based on the user input and pattern; and rendering the final output comprising the mutated audio file based on the user input, pattern, and upload.

### TECHNICAL FIELD

This invention relates generally to the field of media production. More specifically, the invention discloses new and useful methods and systems for generating mutated media fragments for media production.

### BACKGROUND

Since the advent of software-based programs that allowed musicians and producers (m/p) to record and playback notes previously recorded, sequencers, particularly digital audio workstations (DAWs), has been a mainstay in contemporary music production. Aside from offering robust editing and recording tools, DAW’s also allowed the m/p to capture MIDI data and utilize sample libraries. Aside from the variety of programmable controls, including generative looping of evolving patterns of notes, the m/p may also exploit the technology to connect with virtual instruments implemented as software plug-ins; long gone are the days of each synthesizer needing a dedicated keyboard—or even having to lug around the physical instrument in the first place. Despite its widespread adoption, it is largely being underused—or worse, misused—due to its complexity of use. The long learning curve and the prohibitive “time-cost” serve as a barrier for an entry-level m/p to extract the full potential of currently offered DAW’s.

While attempts have been made for a more intuitive interface to better match m/p workflows-regardless of experience-they have done little to relive the “time-cost” problem. The industry has dealt with this problem with product segmentation: a dedicated tier for each a beginner, experienced, and expert m/p. The shortcoming of this approach is that the tiers are no different in terms of user interface icons, graphics, prompts, controls, etc. Rather, they simply offer a smaller tool bag to a beginner. Needless to say, while this approach may offer a certain “ease of use”, unfortunately, it also offers a “limit on use”, since the entire suite of tools is not available.

To that end, there is a void in the market and art for a DAW-style interface that outputs an archive of ‘set-it and forget-it procedurally generated audio fragment/s for downstream audio integration. Procedurally generated audio fragment/s that are mutated from an original input based on user-trained inputs. A pipeline that delivers ease of use while not compromising the suite of offerings and each tool’s capability. Ease-of-use including for graphically interactive ways for a user to self-tune during mutation. For that matter, there is likewise a void in the art to allow a user to intuitively interface with a neural network-trained pipeline for procedurally generating any media fragment for any media integration. Solutions are sorely needed to address the twin issues of non-intuitiveness and a limited toolkit, both of which are bottlenecking creative endeavors across several fields—the most salient of which is audio/music production due to the non-visual nature of the output.

### SUMMARY

In one generalized aspect, disclosed herein are methods and systems for mutating a media file output, comprising the steps of: a. receiving a user input, wherein the user input is at least one of a media file and/or a response to a survey from a user; b. A method for mutating an audio file, said method comprising the steps of receiving a user input, wherein the user input is at least one of an audio file and/or a response to a composition survey from a first user; entering at least a pattern into a grid sequencer by selecting any number of squares in the grid, wherein each square represents a particular count occupancy at a particular count in a musical composition bar that the user prefers to render as a final output; uploading at least one ‘good’ and ‘bad’ audio file sample by the user to affect the particular count occupancy based on the user input and pattern; and rendering the final output comprising the mutated audio file and a visualization of the grid sequencer in terms of an indicator of a probability of a particular count occupancy based on the user input, pattern, and upload. Forms of media may include any media with any audio and/or video playback in real-time or not. One example may be an audio pipeline-coupled to an audio input source, neural network (more particularly, weighted-averaged), and a composition engine-that procedurally generates mutated fragment/s (segment/s) of the audio file based on a current and/or historically tracked user submission (input x...n, etc.). The visually indicative grid sequencer with beat count occupancy probabilities in integer form (optionally, color-coded), along with the user-training features provides a higher resolution of user specificity, with tremendous ease of use in fine-tuning a mutation in a procedurally generated lineage of derived fragments by the user’s preference.

Each fragment may optionally be archived for color-spectrum/rated display for visual/fast retrieval of a fragment, or to reorient the currently processed fragment by mining for a more preferred region in the ‘harvest-graph’. The mining may be performed quicker (with far greater ease of use) with the guidance of the color spectrum feature of the ‘harvest-graph’, allowing users to make a ‘quick-capture’ comparative based on the likeness of color to a reference harvest/fragment/segment/file. Furthermore, each archived fragment may additionally be saved, searched, and shared-in any one of a file form, indexed tags, user input, grid sequencer input pattern, grid sequencer evolving pattern with count occupancy probabilities, for a second user to ‘germinate’ the ‘seed’ based on their ‘mutation-tuning’ preferences.

The lynchpin of this hyper-specific ‘mutation tuning’, is the option for users to submit training samples, designated as ‘good’ or ‘bad’ audio samples by the user based on his or her personal preference. In one generalized aspect, disclosed herein are also systems and methods for mutating a media harvest, comprising the steps of: a) receiving user input, wherein the user input is at least one of an audio (media) file and/or a response to a survey from a user; and b) generating a mutated audio fragment based on the user input, and ‘good′/‘bad’ sample audio files submitted by the user. Furthermore, the pipeline uses further submissions/inputs from the user and the composition engine to mutate and guide these germinated harvest results in favorable ways, where ‘good’ submissions increase the characteristics’ associated with the corresponding algorithm variables and the opposite effect occurs for ‘bad’ submissions. Furthermore, while some aspects may not require pattern entering into the grid sequencer by the user as a starting point in the pipeline, processing/procedural generation may output a visually indicative grid sequencer with beat count occupancy probabilities in integer form (optionally, color-coded) as well, to visually allow the user to adjust-on-the-fly parameters/training uploads to adjust the count occupancy probabilities in near-time-and in turn, output a more user-tuned ‘mutated fragment’. These and other features and improvements of the present application will become apparent to one of ordinary skill in the art upon review of the following detailed description when taken in conjunction with the several drawings and the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings which:

FIG. 1 illustrates an exemplary networked environment of the mutation tuning pipeline in a system block diagram, in accordance with an aspect of the invention;

FIG. 2 illustrates an exemplary mutation tuning engine (MTE) in system block diagram form, in accordance with an aspect of the invention;

FIG. 3 illustrates a screenshot of an exemplary user input interface, in accordance with an aspect of the invention;

FIG. 4 illustrates a schematic of a visually indicative grid sequencer (VIGS), in accordance with an aspect of the invention;

FIG. 5 illustrates an interaction flow of the mutation tuning pipeline, in accordance with an aspect of the invention;

FIG. 6 illustrates a process flow of the mutation tuning pipeline, in accordance with an aspect of the invention;

FIG. 7 illustrates a method flow diagram of the mutation tuning pipeline, in accordance with an aspect of the invention.

### DETAILED DESCRIPTION OF THE DRAWINGS

Numerous embodiments of the invention will now be described in detail with reference to the accompanying figures. The following description of the embodiments of the invention is not intended to limit the invention to these embodiments but rather to enable a person skilled in the art to make and use this invention. Variations, configurations, implementations, and applications described herein are optional and not exclusive to the variations, configurations, implementations, and applications they describe. The invention described herein can include any permutations of these variations, configurations, implementations, and applications.

In the following description, numerous specific details are outlined in order to provide a thorough understanding of the invention. It will be apparent, however, to one skilled in the art that the invention can be practiced without these specific details.

Reference in this specification to “one embodiment” or “an embodiment” or “some embodiments” means that a particular feature, structure, or characteristic described in connection with the embodiment(s) is included in at least one embodiment of the invention. The appearances of the phrase “in one embodiment” or “in some embodiments” in various places in the specification are not necessarily all referring to the same embodiment(s), nor are separate or alternative embodiments mutually exclusive of other embodiments. Moreover, various features are described which may be exhibited by some embodiments and not by others. Similarly, various requirements are described which may be requirements for some embodiments but no other embodiments.

As a person skilled in the art will recognize from the previous detailed description and the figures and claims, modifications and changes can be made to the embodiments of the invention without departing from the scope of this invention as disclosed herein the present application. It will be appreciated that, although the methods, processes, and functions of the present application have been recited in a particular series of steps, the individual steps of the methods, processes, and functions may be performed in any order, in any combination, or individually.

Embodiments are described at least in part herein regarding flowchart illustrations and/or block diagrams of methods, systems, and computer program products and data structures according to embodiments of the disclosure. It will be understood that each block of the illustrations, and combinations of blocks, can be implemented by computer program instructions. These computer program instructions may be provided to a processor of a general-purpose computer, special purpose computer, or other programmable data processing apparatus to produce a machine such that the instructions, which execute via the processor of the computer or other programmable data processing apparatus, create means for implementing the functions/acts specified in the block or blocks.

The aforementioned computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks. The computer program instructions may also be loaded onto a computer or other programmable data processing apparatus to cause a series of operational steps to be performed on the computer or other programmable apparatus, to produce a computer-implemented process such that, the instructions which execute on the computer or other programmable apparatus provide steps for implementing the functions/acts specified in the block or blocks.

In general, the word “module” as used herein, refers to logic embodied in hardware or firmware, or to a collection of software instructions, written in a programming language, such as Java, C, etc. One or more software instructions in the unit may be embedded in firmware. The modules described herein may be implemented as either software and/or hardware modules and may be stored in any type of non-transitory computer-readable medium or other non-transitory storage elements. Some non-limiting examples of non-transitory computer-readable media include CDs, DVDs, BLU-RAY, flash memory, and hard disk drives.

### Certain Terminologies

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context dictates otherwise. Any reference to “or” herein is intended to encompass “and/or” unless otherwise stated.

As used herein, an “audio-visual file” or “AV file” is a series of one or more audio-visual (AV) clips recorded on the same video source (e.g., a single video camera). Two or more “parallel AV files” are recordings of the same action recorded on two or more respective video sources.

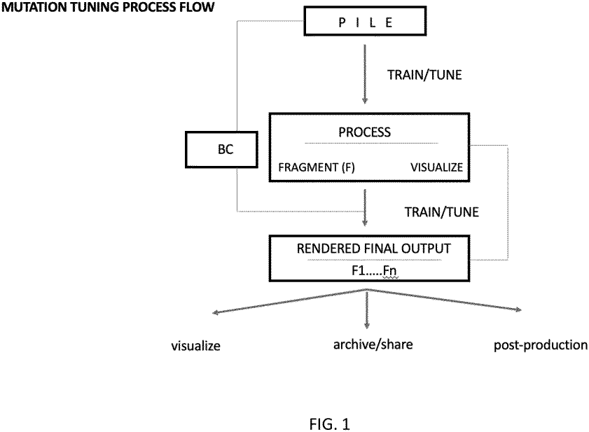

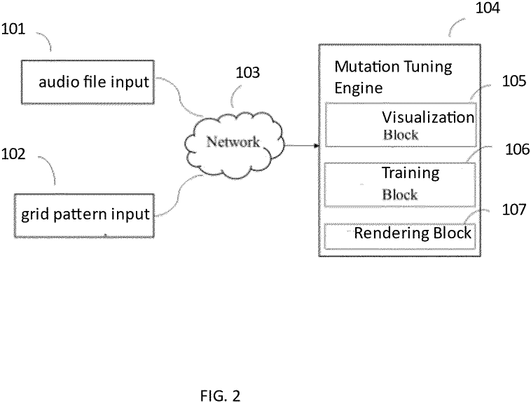

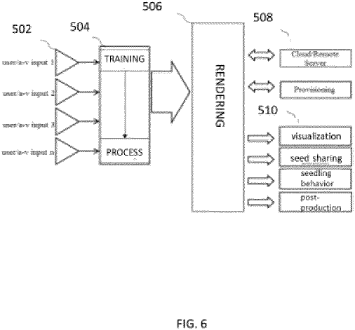

Now in reference to FIG. 1, FIG. 2, and FIG. 5 each illustrates an exemplary system for procedurally generating a media file, and more particularly, a pipeline for mutating an audio file with self-training/tuning. FIG. 1 depicts a schematic of a networked system for rendering an output file with audio production provisioning/analytics, in which the output comprises at least one harvest (file) mutated from the original input (grid pattern input, loaded file, or entered parameter/tuned (PILE). FIG. 2 illustrates a Mutation Tuning Engine (MTE) in block diagram form, while FIG. 5 illustrates an exemplary interaction flow of the networked system-depicting the interrelation between the MTE and its individual blocks/modules with other system components/modules to render the randomized mutations in the self-trained and tuned audio production pipeline.

In one embodiment, a system may comprise: a rendering module 107207; a visualization module 105205; a processor; a memory element coupled to the processor; a program executable by the processor, over a network 103, to render a mutated audio output comprising the mutated audio file and a visualization of the grid sequencer in terms of an indicator of a probability of a particular count occupancy based on the user input, pattern, and upload (PILE) 101102. The interactive visual enables a user to tune/train the construct for hyper-specific randomized mutations/germinations derived from the PILE 101102. As shown in FIG. 2, the rendering module 207 may further be broken down into a series of blocks—each effectuating any one of a confidence, seed, reps, harvest, and/or export. The rendering module receives inputs from the trained PILE (feed-forward or back-propagated) for rendering into a final output (harvested file mutated from the trained PILE) for further germination, export, sharing, or visualization by the visualization module 205. Visualization may comprise both a visually indicative grid sequencer (VIGS) for visualizing sequencer activation for each harvest for further training/tuning, and a harvest-graph enabling the user to interact with a color wheel that color-maps each harvest in the audio output along multiple correlates for a visual-based iterative user training/tuning.

The network 103 may be any suitable wired network, wireless network, a combination of these, or any other conventional network, without limiting the scope of the present invention. A few examples may include a LAN or wireless LAN connection, an Internet connection, a point-to-point connection, or other network connections and combinations thereof. The network 103 may be any other type of network that is capable of transmitting or receiving data to/from host computers, personal devices, telephones, video/image capturing devices, video/image servers, or any other electronic devices. Further, the network 103 is capable of transmitting/sending data between the mentioned devices. Additionally, the network 103 may be a local, regional, or global communication network, for example, an enterprise telecommunication network, the Internet, a global mobile communication network, or any combination of similar networks. The network 103 may be a combination of an enterprise network (or the Internet) and a cellular network, in which case, suitable systems and methods are employed to seamlessly communicate between the two networks. In such cases, a mobile switching gateway may be utilized to communicate with a computer network gateway to pass data between the two networks. The network 103 may include any software, hardware, or computer applications that can provide a medium to exchange signals or data in any of the formats known in the art, related art, or developed later.

Preferred embodiments may include the addition of a remote server or cloud server 508 to further provide for back-end functionality and provisioning/analytical support 510. The server 508 may be situated adjacent to or remotely from the system and connected to each system via a communication network 103. In one embodiment, the server 508 may be used to support user behavior profiling; user history function; predictive learning/analytics; alert function; network sharing function; digital footprint tracking; visualization, graphical interactivity, etc. (510).

The electronic computing device may be any electronic device capable of sending, receiving, and processing information. Examples of the computing device include, but are not limited to, a smartphone, a mobile device/phone, a Personal Digital Assistant (PDA), a computer, a workstation, a notebook, a mainframe computer, a laptop, a tablet, a smartwatch, an internet appliance and any equivalent device capable of processing, sending and receiving data. The electronic computing device can include any number of sensors or components configured to intake or gather data from a user of the electronic computing device including, but not limited to, a camera, a heart rate monitor, a temperature sensor, an accelerometer, a microphone, and a gyroscope, to assess a state of the user for informing the user profile/context for more user-specific randomized mutation/germination. The electronic computing device can also include an input device (e.g., a touchscreen, keyboard, or mouse) through which a user may touch and/or cursor control for input commands. Multiple inputs from a single user computing device (as shown in FIG. 5, depicting a plurality of single-user inputs (a...n)), or multiple inputs from multiple computing devices 502—from single or group use—may be uploaded for training/tuning/processing 504 for rendering/provisioning 506508510.

In another embodiment of the present invention, the rendering/mutation algorithm may employ unsupervised machine learning to learn the features of drum count occupancy probability from the PILE and iterative (i) inputs (any input beyond PILE) for final rendering. For example, a Neural Network Autoencoder can be used to learn the features and then train a Deep Neural Network or a Convolutional Neural Network. The classification may be based on a supervised or unsupervised machine learning technique, and the classification is performed by analyzing one or more features of the inputs (PILE/i). Such approaches result in hyper user specificity, in what may otherwise appear as a randomized mutation, and not to mention a reduction of power consumption and/or increase in the detection speed and accuracy.

Additionally, in another embodiment of the invention, the system may comprise a back-propagated neural network to use a series of externally captured buffers containing known audio-visual sources to aid in real-time recognition of the audio and video input by using a probabilistic approach to determine the presence in a captured buffer. A classification algorithm may be based on supervised machine learning techniques such as SVM, Decision Tree, Neural Net, Ada Boost, and the like. Further, the classification may be performed by analyzing one or more features based on any one of, or combination of, any PILE/i.

While not shown in FIGS. 1, 2, or 5 the final rendering from the rendering module/MTE may bypass either one of the training or visualization modules to render from the PILE/i. In one embodiment, a system may rely strictly on a rendering module for receiving user input, wherein the user input is at least one of an audio file from a first user; entering at least a pattern into a grid sequencer by selecting any number of squares in the grid, wherein each square represents a particular count occupancy probability at a particular count in a musical composition bar that the user prefers to render as a final output; uploading at least one ‘good’ and ‘bad’ audio file sample by the user to affect the particular count occupancy probability based on the user input and pattern; and rendering the final output comprising the mutated audio file based on the user input, pattern, and upload. In yet another embodiment, the system may receive a user input, wherein the user input is at least one of an audio file; enter a pattern into a grid sequencer with columns and rows of boxes, wherein each box of the grid represents a particular count occupancy probability at a particular count in a musical composition bar that the user prefers to render as a final output; render the final output comprising the mutated audio file by the rendering module and a visualization of a grid sequencer in terms of an indicator of a probability of a particular count occupancy based on the user input and entered pattern by the visualization module; and render a second final output mutated from the final output based on at least one of a second received input, the pattern entered, or training samples uploaded by the rendering module.

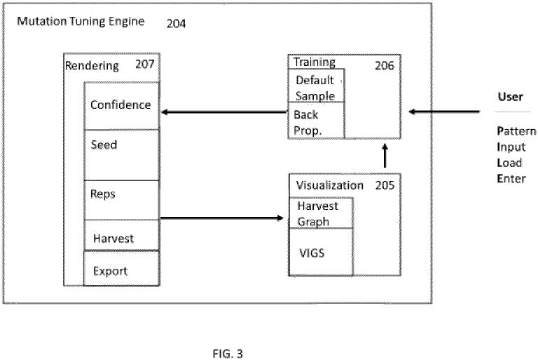

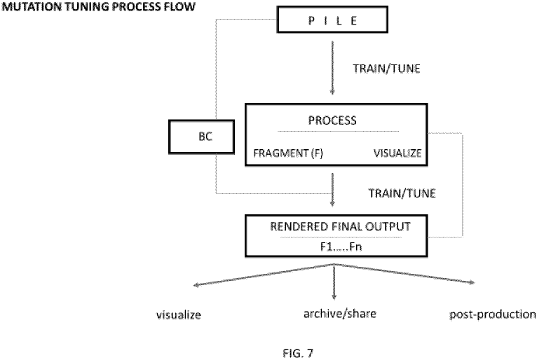

Now in reference to FIG. 3, which illustrates an exemplary interface for user PILE/i—and FIG. 6, which illustrates a process or decision flow in accordance with an aspect of the invention. As shown in FIG. 3, a user is presented with the following interactive screen by accessing a web interface via a browser-enabled device (computing device), for instance, where they can either use the device’s touchscreen, if available, or keyboard and mouse peripherals to enter the PILE/i. The user creates a new project by entering a name they decide and pressing the Create button. An accordion expandable horizontal tab populates the browser window revealing the project interface. The user reviews the first selection list at the top-left region of the interface containing drum sound samples (in .wav, .mp3, & .ogg format), called Hats, ordered by filename. The user either selects from a list/drop-down menu of developer uploaded sounds or decides to upload their own unique sample(s). Once the user selects the Upload button to summon the device’s native OS, the file explorer window, where they can select an audio sample on their device’s hard drive. The two other audio selection lists entitled, Kicks and Snares, are selected, loaded, and summoned similarly.

In continuing reference to FIG. 3, the user then enters a Confidence float value between 0 and 1. To the right of the text box, there are arrows that increment and decrement the Confidence float by a ⅒ of 1 (0.10), which is proportionally aligned to the 0 to 1 parameter. This value will adjust a muting filter for drum count occupancies at a particular count in the bar or sequencer section, where positive and negative integers associated with each count box are displayed. A higher value will only render the highest occupancy count timings for the drums to be rendered to the final output/mutated file. If a count has a higher integer compared to the others, there is more of a chance that the particular drum sound will be rendered to the repeating bars in the final output/mutated file. If the integers are the lowest, including negative integers, then there is less of a chance. The final output audio file will present all sequencer composition combinations containing the higher occupancy drum counts, where the user’s audio sample selections will be rendered. As seen in the lower portion of the screenshot, the sequencer’s Y-axis will determine whether the audio sample will be a Hat, Kick, or Snare referenced from the three audio sample selection’s matching titles. A lower confidence score means more extreme mutations in the final output/mutated file, in which outlier (extremely high and low integers) drum count integers have a higher chance of being rendered than a higher confidence score. The Confidence value may be seen as an incremental mutation tuning tool allowing for the user to engage in an ever-so-slight germination trajectory.

Below the Confidence drop-down, lies the Seed integer drop-down, specifying an identifier for the random instance the output file was rendered. Different seeds render different composition results in the output audio file within the parameters specified in the confidence score value box. The seed may be seen as a distinct procedurally generated fragment derived from at least one of the user patterns, input, load, or entered. The seed is at least one saved, played- back, uploaded for training, or shared to another user for seed germination based on the other user’s preferences, or scraped to determine the first users’ seedling characteristics (pattern, input, load, or entered). Following the user inputs of a confidence and seed value, the user may then enter in a Reps value by drop-down or manually entering a text/numeric value that indicates how many times the neural network will be trained. By increasing the value of the rep, sequencer composition outliers will be further controlled for. By controlling for the value of the rep, the user has an additional incremental mutation tuning tool-allowing for the user to engage in an ever-so-slight germination trajectory yet again. The user manipulation makes adjustments as a more fine-tuned technique of filtering results that are more or less sporadic, similar to a limiter audio effect where a vocalist’s volume level is more consistently spaced from the microphone. The confidence parameters establish a ceiling with its curvature tightened or loosened by the Reps integer. The default value is 100,000. What’s more, the seeds may be visually depicted in a graph, based on a pre-defined color-coded analogy of a sound/sound feature/sound characteristic for further mutation tuning, processing, sharing, etc.

The user then enters in a Harvest value as an integer, indicating how long the output audio file will be expressed in bars. The value determines the size of the mutated audio file and/or final rendered output. The textbox’s default integer is 4 bars. Each bar will contain a unique mutation making it easier for the user to systematically review them one after another.

The user then presses the Upload button under the Good/1 Batch Size title and an integer indicating the batch collection size the user wishes to reflect in the final rendered audio output file. The user selects the “Upload” button to summon the device’s native OS, the file explorer window, where they can select a text composition file on their device’s hard drive. The user presses the Load Notation button to increment the Good/1 Batch Size integer by one indicating that the user has stored another composition in the good batch group before training the neural network. The user presses the Train Good/1 Batch to train the neural network where the weights between the perceptron beat count and output neuron are represented as 1 or 0, depending on whether loaded as a ‘good’ or ‘bad’ training sample. This is the leading factor in significantly increasing beat count occupancy for the associated X counts in the text composition file. The Training Dataset integer increases by the ‘good’ compositions batch quantity. Conversely, the ‘batch’ composition files negatively affect the weights instead since they belong to the Bad/0 Batch group.

The Beat Chamber (BC) is the composition that is dialed into the sequencer window or dialed automatically by uploading an individual composition file to toggle the beat count squares from light to dark gray (state 1 to state 2). This composition is sent through a channel that bypasses the mutation process from the neural network (FIG. 6 illustrates this BC-bypass and iterative mutation feature by way of the faint blue line). The Beat Chamber is a point of reference for the user as they monitor the mutation process. The user can decide to append the training data with a Beat Chamber composition that can either be categorized as good or bad. The Beat Chamber check-marked button is non-interactive and strictly for displaying occupancy by the loaded filename. If occupied, the light-gray button will turn momentarily yellow. The user presses either the Load Custom BC or Load Default BC button to store the user or developer uploaded text composition or grid sequencer pattern in the Beat Chamber. This is just in case the user wants to reference the developer’s composition if they do not have any composition text files or patterns available. The user presses Clear All Training to delete all training data; therefore turning the Training Dataset to 0, the default value upon visiting the web interface for the first time or creating a new project. What’s more, once the inputs have been trained and processed into the distinct procedurally generated mutated fragments, a visualization of a grid sequencer in terms of an indicator of a probability of a particular count occupancy based on the PILE/i. Again, allowing the user to in real or near time adjust the grid pattern entered (interrelatedness between sequencer grid counts expressed as weights) based on the actual visualized grid pattern output.

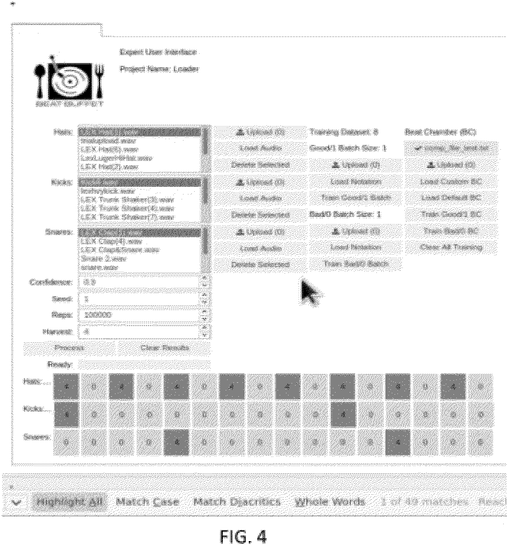

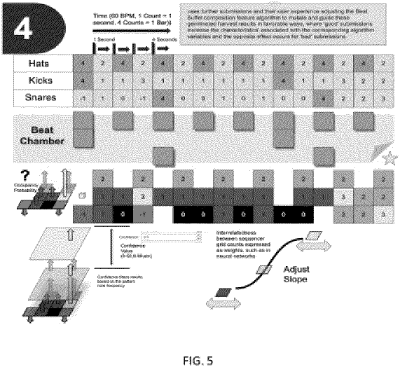

FIG. 4 illustrates an exemplary visually indicative grid sequencer, in accordance with an aspect of the invention. In one embodiment, the middle-layer absent neural network called a Perceptron, processes beat count occupancy integers as input neurons where each of their respective weights are connected to the success level output neuron categorized as good (1) or bad (0). User training increases after a user upload through the process of back-propagation, which minimizes the error rate through automated adjusting of weight values that are initially randomized, ranging from 0-1. The error rate slope at 0 will complete mutation processing and produce a confidence score as a percentage-based decimal. Mutation bars exceeding the confidence minimum entered in the web interface are written to the output file in the order in which the harvest results are collected. The seed number adjusts the order or random instance of the harvest results. The user obtains an audio file with an agreed-upon production likeness between the neural network and how the user thinks like a producer. Song lengths can be specified by the user to automate content they would normally produce manually through moment-by-moment planning. However, in a few steps, a producer can create a musical audio file with constantly interesting song progression according to the user over 10 hours long, for example. Larger songs will require ample hardware resources to minimize rendering time.

### Interface Source Code - the Interface Requires a Jupyter Notebook Server Installed on a Debian Linux System via PIP3

Exemplary Script Excerpt:

import ipywidgets as widgets
from time import sleep
import os
from ipywidgets import ColorPicker, Button, HBox, VBox, Box, Layout,
ButtonStyle
from ipywidgets import GridBox, Label, ToggleButton, BoundedIntText, Select,
Text
import math
#import IPython.display as ipd
from ipywidgets import FileUpload
#hello=“hello”
#labelWidget = widgets.Label(value = r’\(\color{red}\fontsize{9.6}{‘ +
str(hello) + ’}\)’)
upload = FileUpload()
#from IPython.display import clear_output
tds = “Training Dataset”
sle_siz = 5
check_pass = 0
###### widgets ########
bat_1 = os.listdir(‘/root/neuralscan/simple-neural-
network_revamped/beat_frame/’)
bat_0 = os.listdir(‘/root/neuralscan/simple-neural-
network_revamped/beat_frame_off/’)
bc_occ = os.listdir(‘/root/neuralscan/simple-neural-
network_revamped/beat_chamber/’)
##print(len(entries))
file = open (“/root/logol.jpg”, “rb”)
image = file.read()
logo = widgets.Image(
value=image,
format=‘png’,
width=150,
height=200,
)
difficulty_label = widgets.Label(value=“Expert User Interface”)
prj_label = widgets.Label(value=“Project Name: Loader”)
drum_samp_arr = [“LexLugerHiHat.wav”,“lexhvykick.wav”,“lexsnarel.wav”]
, , ,
select_sample = os.listdir(‘/root/neuralscan/samples/’)
drum_type=widgets.widgets.Select(
options=select_sample,
#options=[‘kick’, ‘snare’, ‘high hats’],
#value=‘kick’, # Defaults to ‘pineapple’
#layout={‘width’: ‘max-content’}, # If the items’ names are long
description=‘Drum Type:’,
disabled=False
)
, , ,
select_hats = os.listdir(‘/root/neuralscan/samples/hats/’)
hats_menu=widgets.Select(
#options=[“kick1”, ‘kick2’, ‘kick3’],
options=select_hats,
#value=‘kick1’,
# rows=10,
description=‘Hats:’,
disabled=False
)
, , ,
def on_value_change2(change):
if str(sample_menu.value) == str(change[‘new’]):
print(“sample change”)
#if str(drum_type.value) == “hats”:
# print(drum_samp_arr)
# drum_samp_arr[0] = sample_menu.value
# print(drum_samp_arr)
#if str(drum_type.value) == “kicks”:
# print(drum_samp_arr)
# drum_samp_arr[1] = sample_menu.value
# print(drum_samp_arr)
#if str(drum_type.value) == “snare”:
# print(drum_samp_arr)
# drum_samp_arr[2] = sample_menu.value
# print(drum_samp_arr)
def on_value_change(change):
if str(drum_type.value) == str(change[‘new’]):
print(“drum type change”)
sample_menu.options =
os.listdir(“/root/neuralscan/samples/”+str(drum type.value)+“/”)
#if str(drum_type.value) == “hats”:
# sample_menu.value = drum_samp_arr[0]
#if str(drum_type.value) == “kicks”:
# sample_menu.value = drum_samp_arr[1]
#if str(drum_type.value) == “snare”:
# sample_menu.value = drum_samp_arr[2]

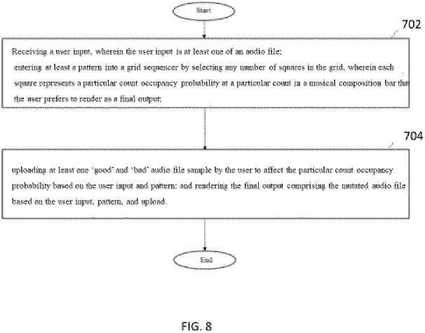

FIG. 7 illustrates an exemplary method flow in accordance with an aspect of the invention. In one embodiment, the method entails the steps of 1) receiving user input, wherein the user input is at least one of an audio file; 2) entering at least a pattern into a grid sequencer by selecting any number of squares in the grid, wherein each square represents a particular count occupancy probability at a particular count in a musical composition bar that the user prefers to render as a final output; 3) uploading at least one ‘good’ and ‘bad’ audio file sample by the user to affect the particular count occupancy probability based on the user input and pattern; and 4) rendering the final output comprising the mutated audio file based on the user input, pattern, and upload (PILE/i). In other embodiments, the method may entail the steps of rendering the final mutated audio file (archived for sharing, integrated into production, or forwarded for further germination) strictly based on the iterative mutation tuning of the user with the above-mentioned tuners (confidence value, reps value, harvest value, etc.). These tuners—otherwise known as user input/s, and/or, collectively as a user composition survey—may be the exclusive input basis for the mutation tuning (initially and/or iteratively), obviating the step of user training. In yet other embodiments, the system may not require a grid sequencer pattern entering, but rather rely on a text file input or drop-down user input to inform the pipeline of count occupancy probabilities. In yet other embodiments, the iterative training may additionally be facilitated with the aid of a visually indicative grid sequencer (VIGS), allowing the user to visualize the actual count occupancy probabilities after initial training/processing. The indicators of probability once trained/processed may prompt the user to adjust/tune the sound of the mutated file (harvested seed) by adjusting the grid sequencer pattern accordingly. Likewise, the near-time tuning may also be facilitated with the visual aid of the harvest graph-enabling the user to drag and click across a multi-correlate color wheel of seeds, oriented based on a sound or signal feature homology. It is to be appreciated by a person of ordinary skill in the art that the visual aids described above may not be required for the user to achieve mutation tuning as contemplated by the present invention.

Embodiments are described at least in part herein with reference to flowchart illustrations and/or block diagrams of methods, systems, and computer program products and data structures according to embodiments of the disclosure. It will be understood that each block of the illustrations, and combinations of blocks, can be implemented by computer program instructions. These computer program instructions may be provided to a processor of a general-purpose computer, special purpose computer, or other programmable data processing apparatus to produce a machine such that the instructions, which execute via the processor of the computer or other programmable data processing apparatus, create means for implementing the functions/acts specified in the block or blocks.

What is claimed is:

1. A method for mutating an audio file, said method comprising the steps of:
receiving a user input, wherein the user input is at least one of an audio file from a first user;
entering at least a pattern into a grid sequencer by selecting any number of squares in the grid, wherein each square represents a particular count occupancy probability at a particular count in a musical composition bar that the user prefers to render as a final output;
uploading at least one ‘good’ and ‘bad’ audio file sample by the user to affect the particular count occupancy probability based on the user input and pattern; and
rendering the final output comprising the mutated audio file and a visualization of the grid sequencer in terms of an indicator of a probability of a particular count occupancy based on the user input, pattern, and upload.

2. The method of claim 1, wherein the audio files are at least one of a drumbeat sample categorized as either a hat, kick, or snare.

3. The method of claim 2, wherein the audio files are at least one of uploaded from the user, uploaded from a shared pool or pre-installed by a developer.

4. The method of claim 1, further comprising a confidence value entered by the user in which the value represents an extent of a muting filter to affect drum count occupancies at a particular count in the bar.

5. The method of claim 4, wherein the confidence value entered is an integer within a range of integers, wherein higher integers within the range result in a higher probability of rendering the highest occupancy counts to be rendered to the final output.

6. The method of claim 4, wherein the confidence value entered is an integer within a range of integers, wherein lower integers within the range result in a lower probability of rendering the highest occupancy count to be rendered to the final output.

7. The method of claim 1, wherein the uploaded “good” and “bad” audio files train a neural network to determine interrelatedness between sequencer grid counts expressed as weights to determine which count is expressed in the mutated audio file and/or final output.

8. The method of claim 1, further comprising a harvest value entered to determine the size of the mutated audio file and/or final rendered output as a function of size.

9. The method of claim 1, wherein the mutated audio file is referred to as a seed, wherein the seed is a distinct procedurally generated fragment derived from at least one of the user pattern, input, load, or entered.

10. The method of claim 9, wherein the seed is at least one of saved, played-back, uploaded for training, or shared to another user for seed germination based on the other users preferences, or scraped to determine the first users seedling characteristics (pattern, input, load, or entered).

11. A method for mutating an audio file, said method comprising the steps of:
receiving a user input, wherein the user input is at least one of an audio file;
entering at least a pattern into a grid sequencer by selecting any number of squares in the grid, wherein each square represents a particular count occupancy probability at a particular count in a musical composition bar that the user prefers to render as a final output;
uploading at least one ‘good’ and ‘bad’ audio file sample by the user to affect the particular count occupancy probability based on the user input and pattern; and
rendering the final output comprising the mutated audio file based on the user input, pattern, and upload.

12. The method of claim 11, further comprising a confidence value entered by the user in which the value represents an extent of a muting filter to affect drum count occupancies at a particular count in the bar.

13. The method of claim 12, wherein the confidence value entered is an integer within a range of integers, wherein higher integers within the range result in a higher probability of rendering the highest occupancy counts to be rendered to the final output.

14. The method of claim 12, wherein the confidence value entered is an integer within a range of integers, wherein lower integers within the range result in a lower probability of rendering the highest occupancy count to be rendered to the final output.

15. The method of claim 11, wherein the mutated audio file is referred to as a seed, wherein the seed is a distinct procedurally generated fragment derived from at least one of the user pattern, input, load, or entered.

16. The method of claim 15, wherein the seed is at least one of saved, played-back, uploaded for training, or shared to another user for seed germination based on the other users preferences, or scraped to determine the first users seedling characteristics (pattern, input, load, or entered).

17. The method of claim 11, further comprising a visualization of a grid sequencer in terms of an indicator of a probability of a particular count occupancy based on the user input and entered pattern.

18. The method of claim 11, wherein the mutated audio file is referred to as a seed, wherein the seed is a distinct procedurally generated fragment derived from at least one of the user pattern, input, load, or entered for archive, share, playback, uploaded for training.

19. The method of claim 18, wherein a plurality of analogous seeds are visually depicted in a graph based on a pre-defined analogy of sound for further mutation tuning.

20. A system for mutating an audio file, comprising:
a rendering module;
a visualization module;
a processor;
a memory element coupled to the processor;
a program executable by the processor, over a network, to:
receive a user input, wherein the user input is at least one of an audio file;
enter a pattern into a grid sequencer with columns and rows of boxes, wherein each box of the grid represents a particular count occupancy probability at a particular count in a musical composition bar that the user prefers to render as a final output;
render the final output comprising the mutated audio file by the rendering module and a visualization of a grid sequencer in terms of an indicator of a probability of a particular count occupancy based on the user input and entered pattern by the visualization module; and
render a second final output mutated from the final output based on at least one of a second received input, pattern entered, or training samples uploaded by the rendering module.
